(19) United States
(12) Patent Application Publication
(10) Pub. No.: US 2013/0339270 A1
(43) Pub. Date: Dec. 19, 2013

(54) SYSTEM AND METHOD FOR BUSINESS ENTITIES TO RECEIVE COMMENTS AND FEEDBACK IN REAL TIME

(71) Applicant: GURPREET SINGH, TORONTO (CA)

(72) Inventor: GURPREET SINGH, TORONTO (CA)

(21) Appl. No.: 13/918,099

(22) Filed: Jun. 14, 2013

Related U.S. Application Data
(60) Provisional application No. 61/659,499, filed on Jun. 14, 2012.

(51) Int. Cl. G06Q 30/02

(52) U.S. Cl. CPC G06Q 30/0281
USPC 705/346

(57) ABSTRACT

A system and method for collecting feedback in real-time from the customers of the business entities that need physical space to operate, while customers are present at the physical location, through use of browser run feedback application on the internet or intranet enabled mobile devices of customers, where customer opts to wirelessly connect their mobile device with the feedback software and the software: verifies customer's presence on business premises; initiates the feedback session; presents the identification and feedback forms to the mobile device; monitoring the feedback sessions; captures and relays the feedback data to the business in real-time and offers reward coupon to the customer after successful submission of the feedback form. System includes display apparatus located at the business premises which enables the mobile devices of the customers to connect with feedback software.

### TECHNICAL FIELD

The present disclosure relates generally to business-customer communication using wireless and other computerized communication devices and, more particularly, to system and method for enabling real-time business-customer communication using wireless and other computer devices.

### BACKGROUND

Over the past decade, businesses that need physical space to operate and interact with their customers have suffered losses in business due to the proliferation of the web-commerce. One of the many reasons for these business losses is the lack of customer feedback mechanisms that will allow owners and operators of said businesses to solicit views of customers (potential or otherwise), analyse these views and act upon them. Advent of online service and product rating websites like Yelp and social media sites like Facebook allowing guest views and feedback has solved the mentioned problem to certain extent but it has created a new set of problems for the said businesses. Firstly, most of these sites were founded on principle of helping customers while businesses can only get public view of the feedback. Thus, a market opinion is created much before businesses have a chance to analyze the feedback and act upon it. Secondly, under the current feedback model, businesses are required to track down these sites, claim their businesses and continually monitor them, a process that can be tedious. Thirdly, authenticity of guest comments is always a concern in above sites as there is no mechanism to connect user with his or her interaction with the business. Lastly, most of the comments on mentioned feedback sites are from users who had bought products and services from mentioned brick and mortar locations. Thus, businesses may miss the opportunity of collecting feedback from genuine potential customers who visited the physical location and decided to move on.

With advent of mobile smartphones, a new trend has been the use of mobile applications or apps to gather feedback. These mobile apps may be location-based social networking website for mobile devices like Foursquare or fully custom built applications for customers of particular business. Social apps have drawbacks similar to that of Facebook and Yelp as discussed previously in [0002]. Main drawback of custom built apps is that these apps require installation on the mobile device wherein substantial personal information may be requested during the installation, making it impossible for customer to provide feedback annonymously. Further, customer may be required to download custom built app of each business visited, a task which requires time and consumes precious resources on the mobile device: battery and data.

There are other technologies that allow users to provide feedback based on the location of phone as determined by Global Positioning System or other means like Geo-fencing. These technologies require installation of third-party applications on the mobile device of customer and access to personal information of customer. Further, these technologies are highly intrusive in nature as they require past customer behavior data and continuous monitoring of customer's location.

Businesses that change their geographical location due to nature of their businesses are further disadvantaged. They may be required to carry traditional paper and pen, or rely on web and/or email to receive private feedback. Need for private feedback may be driven by intellectual property considerations and/or to protect identity of the customers. One example of such business may be a client training session conducted by financial advisor at a location convenient to in-training financial consultants. Any of the method discussed previously in [0001], [0002], [0003] or [0004] may not be practical in this situation.

As can be seen, there is a need to have a solution that enables businesses to receive feedback from customers and potential clients related to their business with a permanent or a temporary physical location. In particular, there is a need to receive feedback in real time and in private from genuine customers. These needs and other needs are satisfied by the present invention.

### SUMMARY

Present invention provides a method for businesses that need physical space to operate and interact with their customers to solicit customer comments and feedback through use of mobile terminals and devices. This physical space can be fixed or may change in location depending on the nature of business. Examples of fixed location businesses are retail stores, restaurants, banks, museums, hotels, hospitals, health care centers and educational institutes among others. Examples of businesses that need physical space to operate with changing geographical location are business service providers like trainers, entertainment artists, event organizers etc.

Further, present invention provides a system for feedback solicitation. System described constitutes of: (a) software applications that are executed in part on mobile browsers of customer and partially on the remote located computing systems. (b) Apparatus that contains information for the customer on how to provide feedback and connect with the feedback software.

### BRIEF DESCRIPTION OF THE DRAWINGS

Detailed description in conjunction with the accompanying drawings will provide a complete understanding of present invention wherein:

FIG. 1 is a flowchart that illustrates the basic steps of a method for customers to provide feedback about a business entity with a permanent or a temporary physical location that possesses an assigned display with Quick Response Code and/or Near Field Communication chip, and businesses to receive above feedback in real time;

FIG. 2 is a block diagram that illustrates the basic components of a system which customer is offered to provide feedback and the businesses employ to receive feedback in real time feedback in accordance with embodiment of the present invention;

FIGS. 3A-3B are block diagrams of example mobile devices used by customer to provide feedback.

FIGS. 4A-4C are block diagram of various embodiments of display devices used to solicit feedback from customers by providing them encoded information that can be deciphered by mobile devices of customers.

FIG. 5 is flowchart that illustrates the basic steps of a method which businesses may employ to additionally reward customers who provide useful feedback in accordance with an embodiment of the present invention;

FIG. 6 is a flowchart that illustrates the basic steps of a method which businesses may employ to make customer feedback comments available for public view in accordance with another embodiment of the present invention;

### DETAILED DESCRIPTION

Businesses that require physical space to operate and interact with their customers form the backbone of North American economy. Examples of fixed location businesses are retail stores, restaurants, banks, museums, hotels, hospitals, health care centers and educational institutes among others. In North America, there are more than 1.2 million retail outlets in operation that contribute approximately $4 trillion to the Gross Domestic Product. Conventionally, these businesses have been requesting feedback from customers at their place of business through the use of pre-paid postage comment cards, comment card drop boxes, or through personal inquiry while the customer is at their place of business. These conventional methods ensured that feedback collected is from genuine customers while respecting privacy of customer and business. The drawback with these feedback methods is that they are time consuming to analyze and respond to. Thus main requirements of feedback for such businesses: (a) Quick and easy to analyse and respond to (b) From a genuine customer (c) Respect privacy of customer and business, are not fulfilled using conventional methods. Majority of current web, social and mobile based methods are able to fulfil requirement (a) but only one of the requirements (b) and (c). Various embodiments of the current invention can fulfill all the main three requirements.

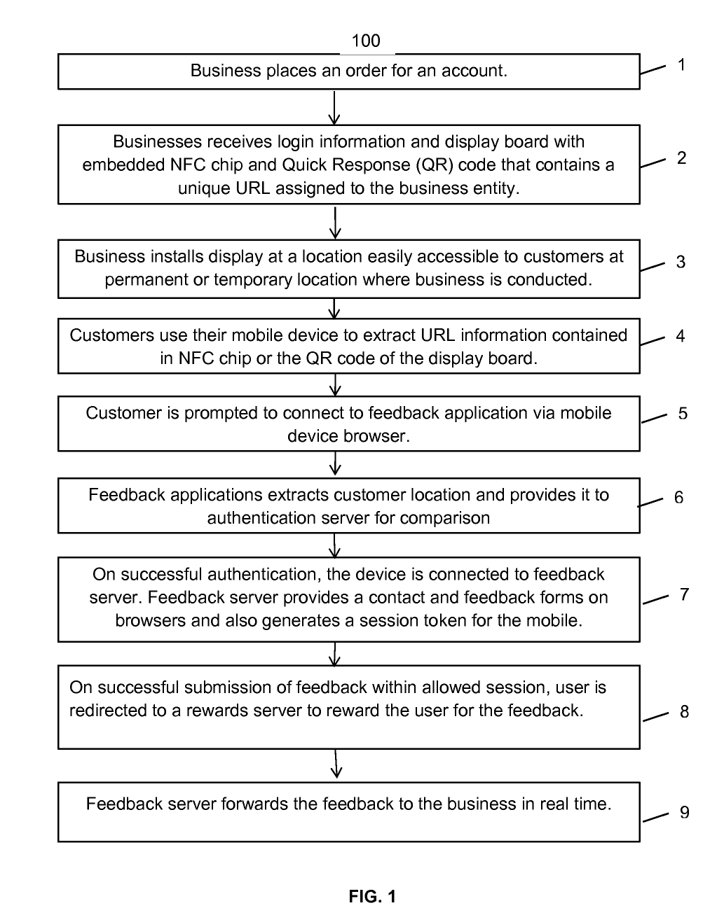

FIG. 1 illustrates a flowchart 100 of the basic steps of the method for customers to provide feedback about a business entity with a permanent or a temporary physical location that possesses an assigned display, and businesses to receive above feedback in real time.

In step 1 of the flowchart 100, business entity subscribes to the feedback plan from the company handling the feedback software and apparatus. A unique uniform resource locator (URL) is generated and embedded into the display device. This URL is linked with location of the business entity and the information stored in the database of the authentication server. For situations where businesses change their location of business frequently, business entities may be provided with key to authentication server to update this information. In some embodiments, this process may be automated through prior determined algorithm.

In step 2 of the flowchart 100, business receives the display device containing the unique URL encoded as Quick Response (QR) Code or embedded into a near field communication (NFC) chip.

In step 3 of the flowchart 100, display containing the unique URL is installed at strategic location within the business premises. This is important as mobile device of customer provides this location for verification before it can connect with the feedback software. If business entity changes its location, the new location information has to be updated by business entity by using the key to authentication server or by sending request to the company handling the feedback software and apparatus.

In step 4 of the flowchart 100, customer with mobile device uses a third party application to extract URL information from QR code or NFC chip located on display device. Third party application feeds this URL to the browser of the mobile device. It is important to note, at this point mobile device may or may not be connected to internet or intranet network. If mobile device is already connected to a network, URL may initiate step 5. If it is determined that mobile device is not connected to a network and business can provide connectivity to such devices through WiFi or other means, an option may be presented to the customer.

In step 5 of the flowchart 100, a handshake between mobile device and feedback software application is offered over browser of the mobile device. Browser may be any compatible browser for the mobile devices including but not limited to Android browser, Safari browser and Mozilla Firefox browser.

In step 6 of the flowchart 100, the feedback application determines the current location of the mobile device using; the Internet Protocol (IP) address database wherein network addresses as linked to specific postal addresses or latitude/longitude coordinates are stored; cell-tower or WiFi antenna triangulation; cell-tower or WiFi antenna proximity or signal strength and/or other appropriate techniques. This location is forwarded to the authentication server which compared it with the location linked with the URL as stored in the database of the authentication server. A match results in execution of step 6 while a mismatch results in an appropriate message to the customer. A match reflects the fact that customer is currently present on the business premises location. This prevents a customer from re-using the URL saved on the mobile from prior visits to the business location and offering irrelevant or false feedback to obtain benefits/rewards of providing the feedback. It is to be noted that browser may or may not request permission from customer for sharing the location data depending upon the settings of the browser.

In an embodiment of the invention, URL embedded in QR code and NFC chip may be changed based on the day and time to ensure that user is not re-using previously stored URL on their mobile. This arrangement can tackle a scenario where a customer passes by the business premises not actually entering it and wants to use the incentive that comes attached with the feedback. This scenario is likely to happen when incentives are offered for the products available with a different business entity. A plasma, Liquid Crystal Display (LCD) or Light Emitting Diode (LED) based display screen may be used for the purpose. NFC chips may be inbuilt or an added to this display. This apparatus may be connected to a pre-programmed micro-chip or a computer which will generate and offer the display code with updated URL while also update the URL stored in the NFC chip. An example may be a television screen connected to a PC. Alternatively, apparatus may be programmed to work on its own if the capability exists. An example of such apparatus is an NFC enabled Android tablet device.

In step 7 of the flowchart 100, the mobile device is connected to the feedback server conditional upon successful completion of the location verification in step 6 as described in [0023]. Feedback server generates a session token and this session token is provided to mobile device by feedback software. Session token is time sensitive and allows customer to connect to the feedback server for a limited period of time also known as session. Feedback server generates the contact and feedback forms and offers them as mobile optimized web pages to the customer during this session. Customers can read the feedback instructions, provide contact information, add comments or the feedback, and submit the content to feedback server during the life of the session utilizing the mobile device. If session is timed out or connection with the server is lost, user will have to return to the physical location of the business to reinstate the connection with feedback server. Feedback server may limit the number of connection attempts by same mobile device during a certain time interval to deter malicious users.

Customer may decide to share his/her contact details in feedback form which business can use to contact user to conduct a more thorough analysis. Customer may also decide to leave contact information blank to submit feedback anonymously.

In step 8 of the flowchart 100, successful submission of feedback within allowed session results in customer being redirected to a rewards server. Rewards server generates a reward coupon and displays it on the browser of mobile device as a mobile optimized web page. Coupon may be time stamped for use within limited time period. This process is automated and rewards are predetermined.

In step 9 of the flowchart 100, feedback server forwards the feedback to the businesses in real time. Feedback may be forwarded to a web or mobile device of the business manager in form of email or any appropriate message format.

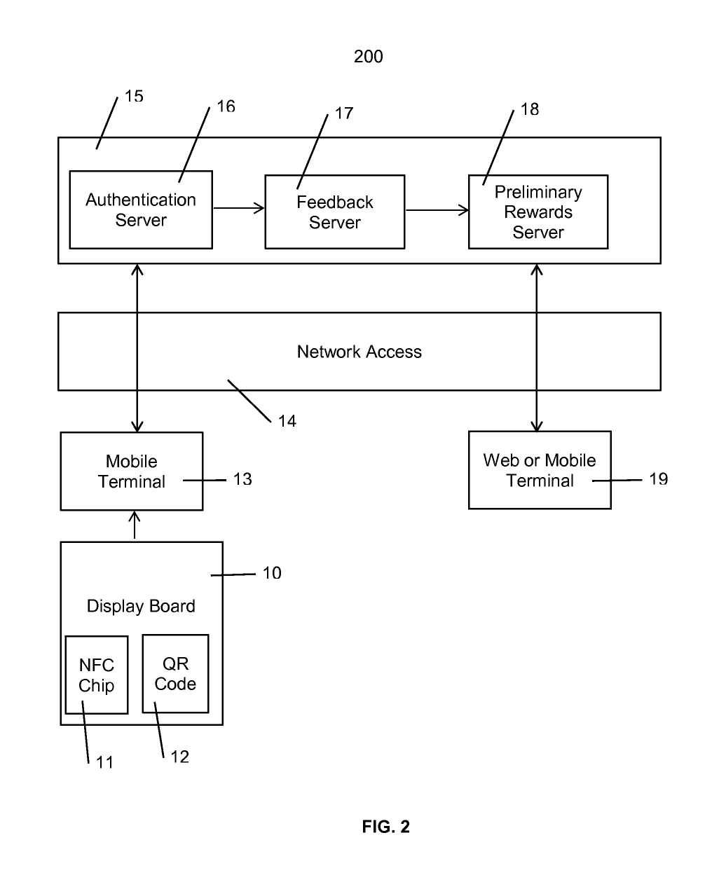

FIG. 2 illustrates a block diagram 200 with the basic components of a system which customer is offered to provide feedback and businesses employ to receive feedback in real time feedback in accordance with embodiment of the present invention.

10 of the block diagram 200 represents display device with QR code 12 and/or an embedded NFC chip 11, each encoded with URL unique to the business entity for initiating the connection between mobile device and feedback software. Display device may be passive or active. Passive display device may contain a printed QR code and/or NFC chip with URL permanently encoded. Active display device may consist of display screen that is plasma, LCD or LED screen wherein this screen may be connected to pre-programmed micro-chip or a computer which will update the QR code to display. Active display screen may contain an embedded NFC chip connected to pre-programmed micro-chip or a computer that can update/modify the URL data stored in this chip. URL updates can prevent frauds as well as help in conforming to changing business or technical requirements.

13 of the block diagram 200 represents a mobile terminal used by customers to connect with feedback software. It may represent any mobile phone or tablet with Android, iOS, Windows or any other suitable operating system. This mobile terminal is capable of connecting with a network using 3G cellular communication system, a wireless local area network (WLAN) or any other appropriate wireless communication system capable of sending and receiving data. 14 represents network access provided to mobile terminal using any of the above methods. This network access is required for feedback software to connect with mobile device. Mobile terminals depicted by 13 are able to decode URL information encoded in QR code and/or NFC chips.

15 of the block diagram 200 represents all-encompassing feedback software. It handles the requests from customer to connect the mobile terminal; determines the current location of the mobile terminal 13; provides the mobile terminal location to the authentication server 16 for the verification of customer's presence at the physical location of the business; initiates a feedback session using a session token generated by a feedback server 17; presents the optimized customer identification and feedback forms generated by a feedback server to the mobile device; monitors the feedback session; captures the feedback data and stores it in the feedback server; relays the feedback data stored in feedback server to the businesses in real-time; and offers the reward coupon to the feedback provider as generated by the rewards server 18 after successful submission of the feedback form. Arrows in the illustration 200 depict the flow of information. Authentication server, feedback server and rewards server comprise of computer software programs capable of reading, analysing and updating databases that run on networked computers hosted in the business premises or on the networked remote computer systems hosted on the cloud system.

Block 19 of the block diagram 200 represents computing device used by business entity to receive feedback in real-time. It may be a mobile phone, a tablet or a personal computer with network access 14. The feedback may be received in form of web page, an email or message that can be optimally displayed on the device. Business owners who operate multiple businesses may find real-time feedback very useful in keeping abreast with happenings at the business locations.

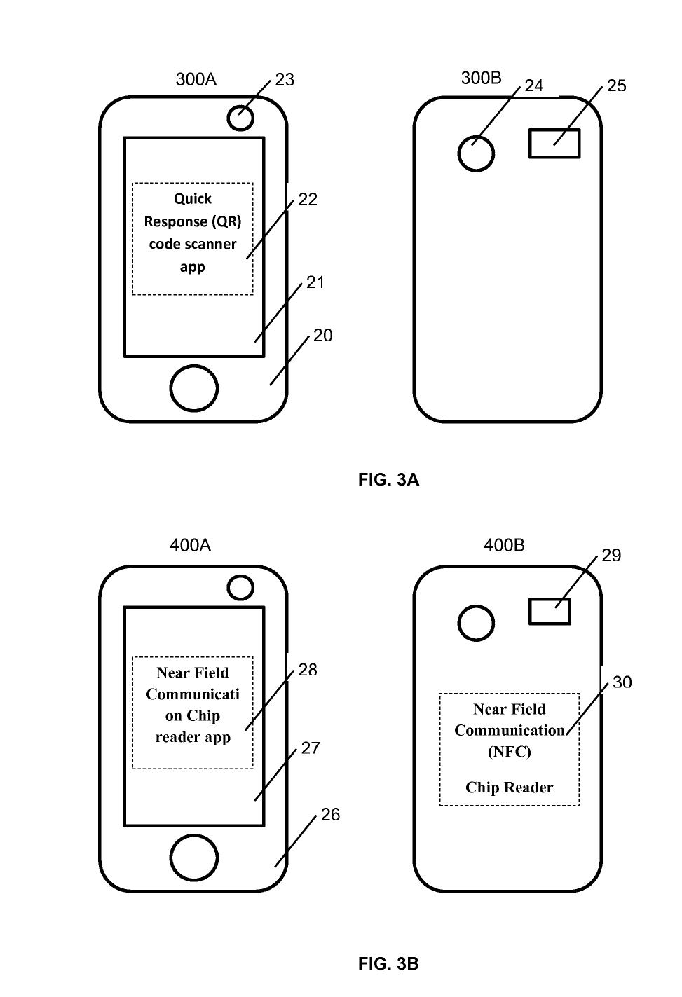

FIG. 3A illustrates an embodiment of a mobile terminal 20 that can extract URL information from QR code. Diagram 300A depicts front of the mobile terminal with screen 21, a front camera 23 and a QR code reader app 22. Diagram 300B depicts back of the mobile terminal with a back camera 24 and hardware 25 used to wirelessly connect with a network 14 as shown in FIG. 2. QR code reader app uses one of the cameras to capture QR code and extract URL information.

FIG. 3B illustrates an embodiment of a mobile terminal 26 that can extract URL information from NFC chip. Diagram 400A depicts front of the mobile terminal with screen 27 and a NFC reader app 28. Diagram 400B depicts back of the mobile terminal with NFC chip reader hardware 30 and hardware 29 used to wirelessly connect with a network 14 as shown in FIG. 2. NFC reader app uses the NFC chip reader hardware to extract URL from NFC chip.

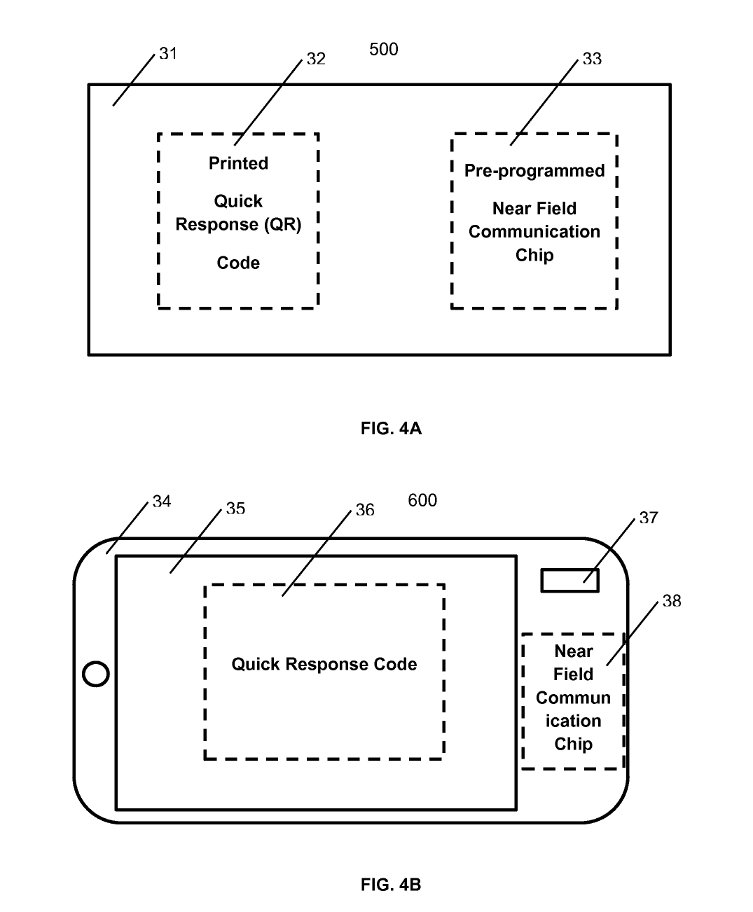

FIG. 4A illustrates an embodiment 500 of the display device. This display is a low cost display, with QR code 32 printed on a paper and/or a pre-programmed NFC chip 33 affixed to support surface 31 that may be made of wood or metal. Display may contain a symbolic or in words invitation for customers to scan the QR code and/or tap on the display.

FIG. 4B illustrates another embodiment 600 of the display device. This display is a tablet device 34 with: a screen 35 that displays the QR code 36; an NFC chip 38 that can be updated with updated with modified URL data as per requirement; and hardware 37 to provide network connectivity. This embodiment is useful when a frequent update of unique URL is desired. A simple computer program executed on Tablet device or remotely can send instructions in automated or manual fashion to update the screen with new Quick Response code or update the NFC chip with a new URL.

FIG. 4C illustrates another embodiment 700 of the display device. This display is a monitor 39 with plasma, LCD or LED screen 40 that can display the QR code 41 as generated by computing device 42 connected with the display. The computing device is capable of producing electronic version of QR code for display on the monitor.

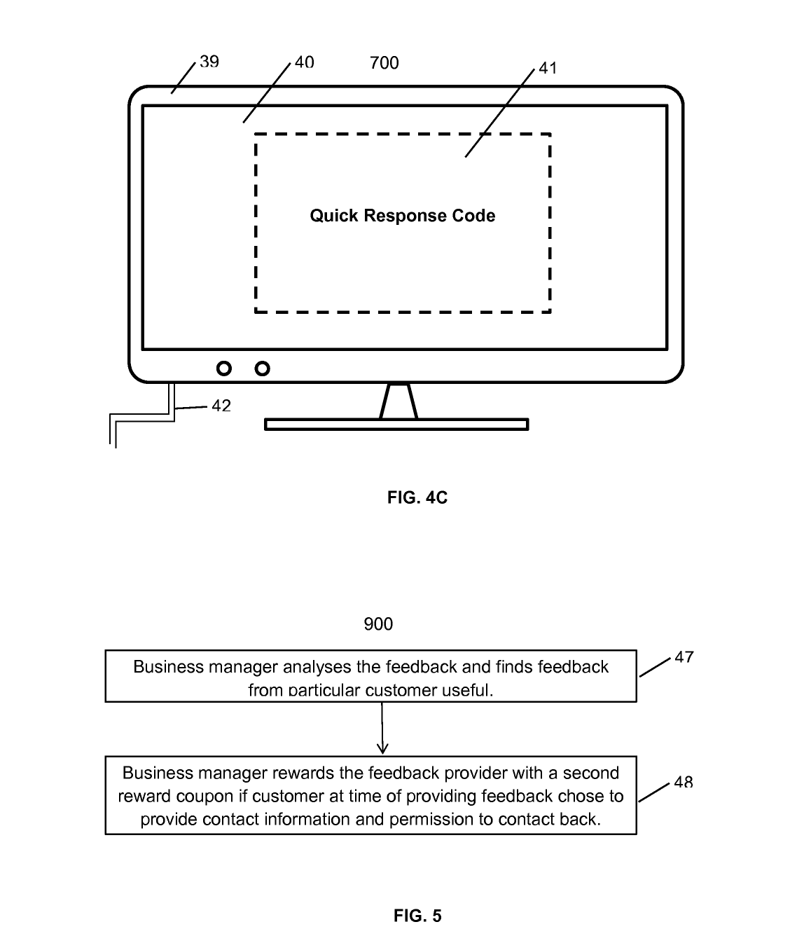

FIG. 5 illustrates an embodiment 900 of method 100 as illustrated in FIG. 1. In this embodiment, additional steps of allowing businesses to further reward customer if business finds the feedback useful are incorporated. A second reward coupon can be sent conditional upon customer choosing to provide contact information along with the permission to contact. In step 47, business entity analyses the feedback using analysis software and other tools to determine its usefulness. In step 48, business entity rewards the feedback provider with a second reward coupon by sending to customer using an email, messaging program, short messaging service (SMS) or any other appropriate tool.

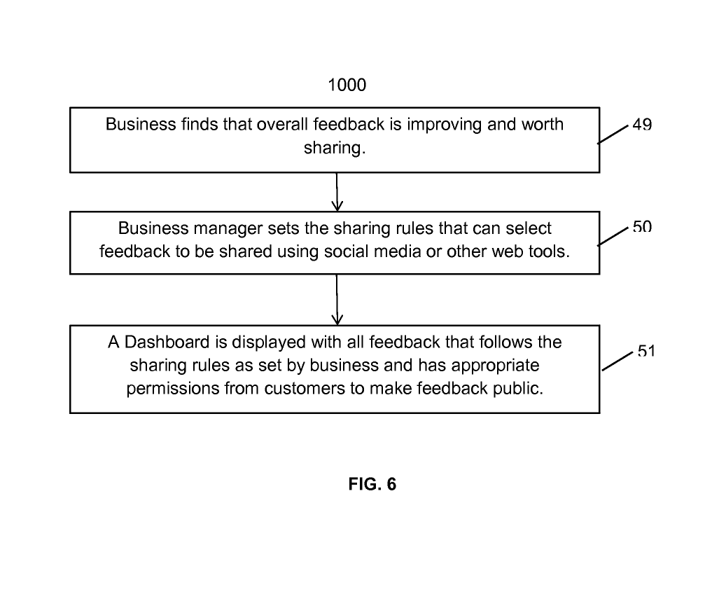

FIG. 6 illustrates another embodiment 1000 of method 100 as illustrated in FIG. 1. In this embodiment, additional steps of allowing businesses to link the feedback dashboard to social media and/or other web tools thus making it available for public view conditional upon privacy requirements imposed by customer are incorporated. For example, if customer has provided contact details but no permission to make it public, customer comments will be excluded from public dashboard. Businesses may also choose to impose conditions that feedback software can use to vet and select the feedback from database before displaying it. In step 49, business entity finds that feedback of certain nature from a customer or customers can be shared with other customers or general public due to its usefulness. In step 50, business entity sets the sharing rules that can select feedback to be automatically shared using social media or other web tools. In step 50, business entity selects the social media and web tools to be used. A Dashboard is displayed with all feedback on social media tools that may include but not limited to Facebook and Twitter. Dashboard may be customized if the permissions for customization exist.

What is claimed is:

1. Method for collecting feedback from the customers of the business entities that need physical space to operate, while customers are present at the physical location, through use of browser run feedback application on the internet or intranet enabled mobile devices of customers, wherein the method comprises of: customer opting to wirelessly connect their mobile device with the feedback software, verification of customer's presence at the physical location of the business by the authentication server, initiating the feedback session using a session token generated by feedback server; presenting the optimized customer identification and feedback forms generated by a feedback server to the mobile device; monitoring of the feedback session, capturing the feedback data entered by customer and storing it in feedback server, relaying of the feedback data stored in feedback server to the businesses in real-time and offering reward coupon generated by the rewards server to the customer after successful submission of the feedback form.

2. The method of claim 1, wherein the authentication server, feedback server and rewards server comprise of computer software programs capable of reading, analysing and updating databases that run on networked computers hosted in the business premises or on the networked remote computer systems hosted on the cloud system.

3. The method of claim 1, wherein the wireless connection between the mobile device of feedback provider and feedback software is initiated over internet or intranet using Hypertext Transfer Protocol or Hypertext Transfer Protocol Secure by: scanning the Quick Response code using the Quick Response code scanner of the mobile device wherein the uniform resource locator unique to the business entity stored in the Quick Response code is acquired by Quick Response code scanner and fed to the mobile browser of the mobile device.

4. The method of claim 3, wherein the unique uniform resource locator for the business is updated based on pre-specified logic that is dependent on the year, month, day and time while the prior uniform resource locators are rendered inactive.

5. The method of claim 1, wherein the wireless connection between the mobile device of feedback provider and authentication server is initiated over internet or intranet using Hypertext Transfer Protocol or Hypertext Transfer Protocol Secure by: tapping near field communication enabled mobile device on the near field communication chip wherein the uniform resource locator unique to the business entity stored in the near field communication chip is acquired by near field communication reader and fed to the mobile browser of the mobile device.

6. The method of claim 5, wherein the unique uniform resource locator for the business is updated based on pre-specified logic that is dependent on the year, month, day and time while the prior uniform resource locators are rendered inactive.

7. The method of claim 1, wherein the verification of the customer is conducted by the authentication server by comparing the acquired location of the customer's mobile device with the location of business entity as stored in the database wherein a successful match results in a generation of feedback session while a failure in match results in an appropriate message on the mobile device.

8. The method of claim 1, wherein the location of the business entity is updated in the database of the authentication server if the geographical location of business entity changes.

9. The method of claim 1, wherein the feedback can be relayed to a dashboard linked to social media and other web tools thus making it available for public view conditional upon privacy requirements imposed by feedback provider.

10. The method of claim 9, wherein the feedback can be filtered based on business defined criteria before displaying on the dashboard linked to social media or other web tools.

11. Software for collecting feedback from the customers of businesses entities that need physical space to operate while customers are present at the business location, when executed on the browser of the mobile device and subsequently on a remote computer, to: receive a request from customer to connect the mobile device with the feedback software, determine the current location of the mobile device, provide the mobile device location to the authentication server for the verification of customer's presence at the physical location of the business; initiate a feedback session using a session token generated by a feedback server; present the optimized customer identification and feedback forms generated by a feedback server to the mobile device; monitor the feedback session; capture the feedback data and store it in feedback server; relay the feedback data stored in feedback server to the businesses in real-time and offer reward coupon to the feedback provider as generated by the rewards server after successful submission of the feedback form.

12. The software of claim 11, wherein the authentication server maintains a database of business locations and unique uniform resource locators associated with these businesses.

13. The software of claim 11, wherein software presents the session token generated by feedback server to the mobile browser as a Hypertext Transfer Protocol cookie or as a parameter in GET or POST query depending upon the permissions provided by feedback provider; and wherein the session token expires after a pre-set duration of time.

14. The software of claim 11, wherein software checks for established session and requests feedback server to generates a mobile optimized contact form and feedback form.

15. Apparatus installed at the location of business to inform customers about the option of onsite feedback, the apparatus comprising of: a display with Quick Response code and an embedded near field communication chip, each encoded with uniform resource locator unique to the business entity for initiating the connection between mobile device and authentication server.

16. The apparatus of claim 15, wherein the display is plasma, Liquid Crystal Display or Light Emitting Diode screen wherein this screen may be connected to pre-programmed micro-chip or a computer that is capable of updating the Quick Response code to display.

17. The apparatus of claim 15, wherein the embedded near field communication chip may be connected to pre-programmed micro-chip or a computer that is capable of updating the data stored in this chip.
